(19) United States
(12) Patent Application Publication
(10) Pub. No.: US 2006/0158652 A1
(43) Pub. Date: Jul. 20, 2006

(54) Measuring soil light response

(76) Inventors: Daniel J. Rooney, Verona, WI (US); Gregory W. Anderson, San Diego, CA (US)

Correspondence Address: DEERE & COMPANY, ONE JOHN DEERE PLACE, MOLINE, IL, 61265, US

(21) Appl. No.: 11/315,600

(22) Filed: Dec. 22, 2005

(30) Foreign Application Priority Data
Jun. 24, 2004 (WO) 2005/003728

(51) Int. Cl. G01J 3/50

(52) U.S. Cl. 356/406

(57) ABSTRACT

A soil measurement probe (21) includes a window (38) mounted in an opening (40) in the outer surface (34) of the probe, a light source (42) disposed within the probe and directed toward the window for illuminating the soil in situ, with light of wavelengths corresponding to the colors red, blue and green, in succession. A photo-detector (44) disposed within the probe is directed toward the window, the photo-detector responsive to light of each of the first and second wavelengths as reflected from the soil in situ. The probe is useful for measuring the color of the soil as an R-G-B measurement. Other soil parameters are obtained by correlation with soil color.

### TECHNICAL FIELD

This invention relates to soil measurement probes and to methods of measuring the response of soil to light in situ.

### BACKGROUND

Various probes have been developed for measuring or viewing soils in situ (i.e., in a subsurface environment), rather than bringing the soil to the surface for analysis. Some probes include sensors that measure probe loads or physical soil properties. Some probes feature windows through which laser light is transmitted into the soil, such as for measuring a fluorescence response. Miniature video cameras have also been installed in probes, for viewing images of the soil in situ.

### SUMMARY

The invention features measuring the response of soil in situ to light of multiple, discrete wavelengths, with which the soil is illuminated in succession by a soil measurement probe.

According to one aspect of the invention, a soil measurement probe has a housing, a window, a light source, and a photo-detector. Preferably, the probe also has a light manifold. In some embodiments, the probe also has an electrical connector at an upper end of the housing, for interfacing with a data transmission cable extending down to the probe from the ground surface. Preferably, the probe defines an internal passage extending through its length and forming a pass-through for wires from down-probe sensors.

The housing defines a force axis and an interior cavity and has an outer surface exposed for sliding contact with soil as the housing is moved through the soil along its force axis. Preferably, the housing also has a buckling strength sufficient to withstand an unsupported axial load of at least two tons (18 kilonewtons) applied along the force axis.

In some applications, the housing is a generally cylindrical body with a closed downhole end. However, different housing shapes are also envisioned. For example, in some embodiments, the housing is shaped to cleave the soil as it is moved laterally through the soil. In embodiments where the housing is a generally cylindrical body with a closed downhole end, the downhole end preferably includes a force sensor configured to measure soil-applied load as the probe is advanced through the soil along the force axis. More preferably, the downhole end includes a first force sensor responsive to normal load applied parallel to the force axis at a distal tip of the probe, and a second force sensor responsive to shear stress applied to the outer probe surface behind the tip.

The window is mounted in an opening in the outer surface of the probe and provides optical communication between the soil and the interior cavity. In some embodiments, the window has an outer surface substantially flush with the outer surface of the probe. The outer surface of the probe preferably has a flat region at this point to facilitate contact between the soil and the window. More preferably, this flat region is open at its lower end, thus providing an unobstructed path for soil approaching the window. In some embodiments, the window is a sapphire disk. Sapphire is preferred for its exceptional hardness and superior abrasion resistance in cooperation with its good optical properties.

The light source is located within the interior cavity and directed toward the window for illuminating the soil in situ alternately with light of a first wavelength and with light of a second wavelength. In some embodiments, the light source is controllable to selectively illuminate the soil with the first and second wavelengths in succession. In a preferred embodiment, the first and second wavelengths correspond to visible colors, preferably with each corresponding to a different one of red, green and blue visible colors. In some embodiments, the light source is also controllable to selectively illuminate the soil with a third wavelength to the exclusion of the first and second wavelengths. More preferably, the first, second and third wavelengths correspond to visible colors of red, green and blue. However, it is envisioned that other wavelengths of light could be used.

In some embodiments, the light source is provided by separate light emitters, with one light emitter configured to emit light at the first wavelength, and another light emitter configured to emit light at the second wavelength. Preferably, these light emitters are light-emitting diodes.

The photo-detector is also located within the interior cavity and directed toward the window. As the soil is illuminated by the light source, the photo-detector responds to light of each of the first and second wavelengths reflected from the soil. In some embodiments, the photo-detector is a light-responsive integrated circuit that outputs a signal with a frequency that varies with light intensity.

In embodiments of the probe with the light manifold, the light manifold defines an illumination channel positioned to direct light from the light source to an interior surface of the window. The light manifold also defines a reflection channel spaced apart from the illumination channel and positioned to provide an optical path from the interior surface of the window to the photo-detector. This configuration of the light manifold blocks direct incidence of transmitted light upon the photo-detector.

In some embodiments, the probe also has a controller adapted to trigger the light source to emit light at the first wavelength, then to cease to emit light at the first wavelength, and to subsequently emit light at the second wavelength. The controller can be connected to the light source via a length of cable extending from the housing. Preferably, the controller triggers distinct emissions of each of the first and second wavelengths within a total elapsed time of less than about one second. More preferably, the controller is adapted to trigger the light source while the probe is advancing through the soil.

According to another aspect of the invention, a soil measurement probe has a housing, a window, an illumination means, and a photo-detector. The housing defines a push axis and an interior cavity. The housing also has an outer surface exposed for sliding contact with soil as the housing is pushed through the soil along its push axis. The window is mounted in an opening in the outer surface of the probe and provides optical communication between the soil and the interior cavity. The photo-detector is disposed within the interior cavity, directed toward the window, and responds to light of each of multiple wavelengths as reflected from the soil in situ. In some embodiments, the probe also has a controller adapted to trigger the illumination means to emit light at the a first wavelength, then to cease to emit light at the first wavelength, and to subsequently emit light at the a second wavelength, then to cease to emit light at the second wavelength, and to subsequently emit light at the a third wavelength.

The illumination means is disposed within the interior cavity and directed toward the window, for illuminating the soil in situ with the multiple light wavelengths in succession. In some embodiments, the multiple wavelengths are a first, a second, and a third wavelength corresponding to the visible colors of red, green, and blue. The illumination means preferably illuminates the soil with each of the wavelengths in succession within an overall time period of less than about one second. In some cases, the illumination means is a light-emitting diode assembly capable of emitting multiple, discrete wavelengths.

According to another aspect of the invention, a soil measurement probe has a housing, a window, a light source, and a sense means. The housing defines a push axis and an interior cavity. The housing also has an outer surface exposed for sliding contact with soil as the housing is pushed through the soil along its push axis. The window is mounted in an opening in the outer surface of the probe and provides optical communication between the soil and the interior cavity. The light source is disposed within the interior cavity and directed toward the window for illuminating the soil in situ alternately with light of a first wavelength and with light of a second wavelength. The first and second wavelengths each preferably corresponds to a different one of red, green and blue visible colors. Preferably, the light source is light-emitting diodes. In some embodiments, the probe also has a controller adapted to trigger the light source to emit light at the first wavelength, then to cease to emit light at the first wavelength, and to subsequently emit light at the second wavelength.

The sense means is disposed within the interior cavity and directed toward the window, for sensing light of each of the first and second wavelengths as reflected from the soil in situ. In some cases, the sense means is a light-responsive integrated circuit.

According to another aspect of the invention, a method is provided for measuring color response of soil. The method includes advancing a probe from a ground surface through subsurface soil, shining a light of a first wavelength into the soil in situ through a window in a side surface of the probe, measuring a first amount of light reflected by the soil back into the probe in response to shining the light of the first wavelength; then, after extinguishing the light of the first wavelength, shining a light of a second wavelength into the soil in situ through the window, and measuring a second amount of light reflected by the soil back into the probe in response to shining the light of the second wavelength. Each of the first and second wavelengths preferably corresponds to a different one of red, green and blue visible colors. For some applications, the method also includes shining a light of a third wavelength into the soil in situ through the window and measuring a third amount of light reflected by the soil back into the probe in response to shining the light of the third wavelength. In some embodiments, the method also includes deriving a numeric R-G-B representation of color of the soil.

The sensor and method described herein can provide a relatively inexpensive means of gathering soil data across a field for the compilation of a soil color map. Such a map can provide an indication of the distribution of nutrient holding capacity or organic matter composition, for example, in agricultural applications. The components can be fashioned to fit within a relatively small diameter, for direct pushes of probes by hydraulic rams, or even fashioned into the soil-contacting surfaces of plow blades or other farm implements. Additional sensors are readily incorporated, for the simultaneous mapping of multiple soil properties.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a profile view of a test vehicle using a soil probe to measure soil properties in situ.

FIG. 2 is a side view of a soil light response probe.

FIG. 3 is a cross-sectional view of the soil light response probe, taken along line 3-3 in FIG. 2.

FIG. 4 is an enlarged cross-sectional view of the color sensor portion of the soil light response probe of FIG. 2.

FIG. 5 is a perspective view of the light manifold of the soil light response probe.

FIG. 6 is a flow chart illustrating the operation of the soil light response probe.

FIG. 7 illustrates the operation of a color sensing plow.

Like reference symbols in the various drawings indicate like elements.

### DETAILED DESCRIPTION

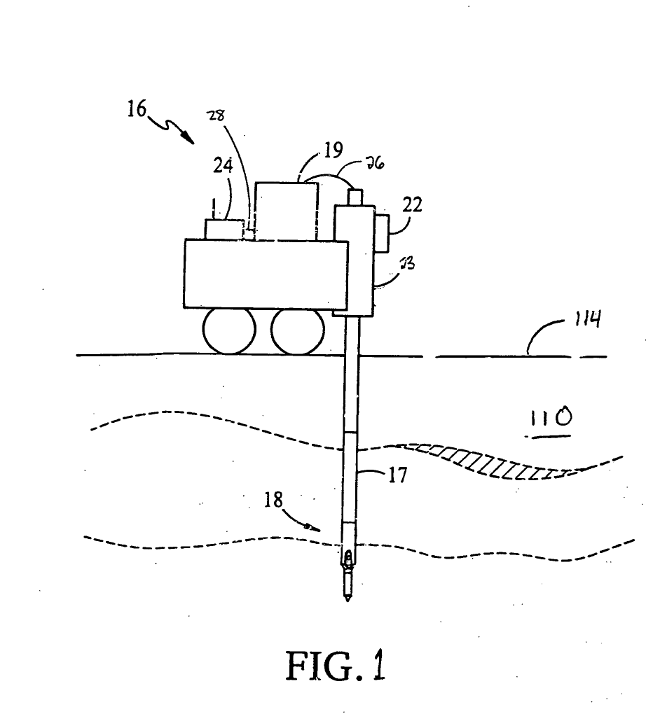

FIG. 1 illustrates a test vehicle 16 adapted to collect in-field subsurface data. Vehicle 16 includes a push system 23 for pushing cone penetrometer (CPT) probes 18 or other invasive sensors from the ground surface 114 into the soil 110 along a selected path, either vertical or angled, at the end of a string of hollow push rods 17. These probes can contain sensors, known in the art, that are responsive to various soil properties. In many cases, signals from such sensors are relayed electrically or wirelessly up to the push vehicle 16 for logging and analysis. Penetrometer sensors can be used to measure or derive soil compaction, grain size, moisture, temperature and resistivity, as well as other chemical and physical properties. Some such sensors are available from Geoprobe Systems, Inc., of Salina, Kans., and Applied Research Associates Inc., of South Royalton, Vt. A probe controller 19 on-board vehicle 16 collects data from deployed sensors 18, with data from in-ground sensors correlated with depth as determined from a depth gage 22, and communicates the data to an acquisition laptop computer 24, which also receives geographic position from an on-board global positioning system (not shown). The on-board data acquisition computer is also capable of integrating data collected from sensors with pre-existing data for the site to develop a site map, and/or relaying raw or processed data off-site via mobile telecommunications link, as described in pending patent application Ser. No. 09/998,863, published as US2003/0083819 A1.

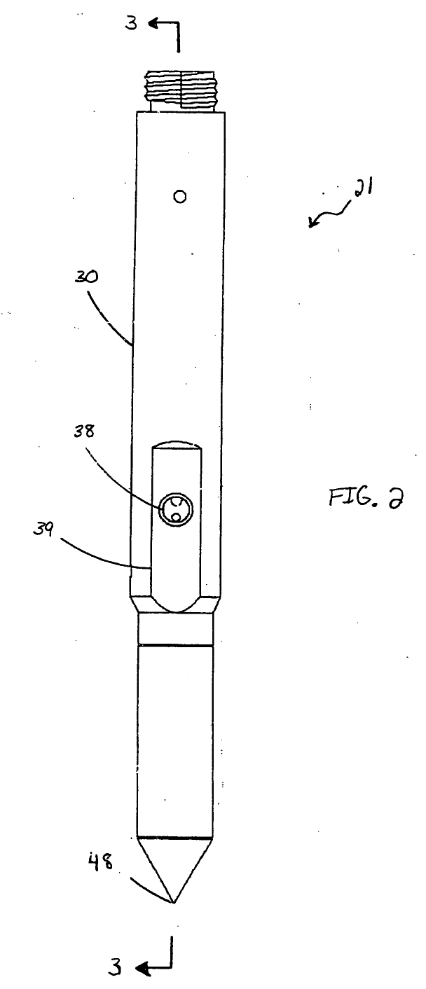

FIG. 2 shows the exterior of a soil light response probe 21 for use with the test vehicle 16 shown in FIG. 1. Probe 21 includes a housing 30, a window 38 mounted in an opening in the housing, and a conical tip 48 to facilitate penetration into the ground. The window 38 is mounted in an opening 40 in a flat area 39 machined in the outer diameter of the body of the housing. The window is substantially flush with the flat area 39. This insures that soil is in contact with the window 38, for better illumination. The housing 30 is of robust design and constructed of hardened steel to withstand the high loads and abrasion that result from being pushed into the ground up to about six feet by a hydraulic ram system.

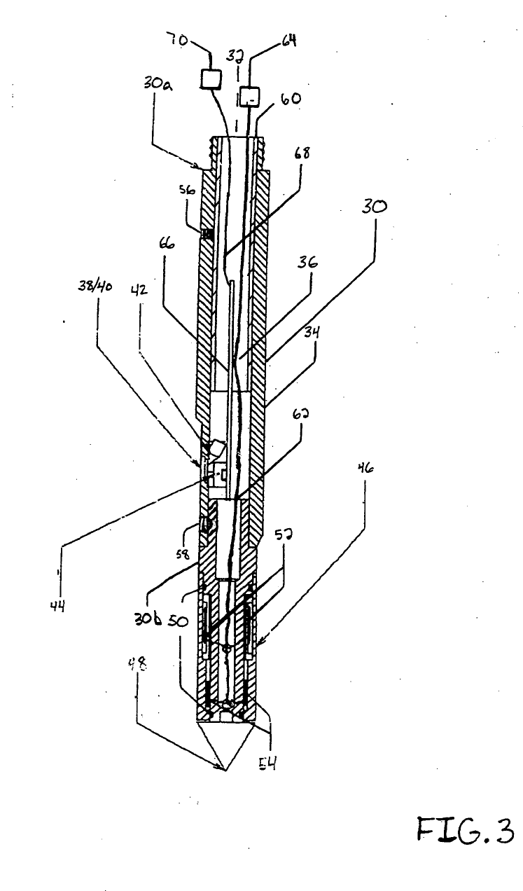

As shown in FIG. 3, housing 30 defines a push or force axis 32. Housing 30 has an upper section 30a and a lower section 30b, held together by a slip fit and a dog-point set screw 58. Housing 30 also has an outer surface 34 exposed for sliding contact with soil as the housing 30 is pushed or pulled through the soil. An interior cavity 36 of the probe contains a light source 42, a photo-detector 44, and a circuit board 66. The window 38 in the probe shown in FIGS. 2 and 3 provides optical communication between the soil and the interior cavity 36 of the probe 21. The light source 42 is directed toward the window 38 for illuminating the soil in situ alternately with light of three discrete wavelengths. The photo-detector 44, also directed toward the window 38, is responsive to light of these three wavelengths as reflected from the soil in situ. The light source 42 is connected to the circuit board 66 by four leads 43 (FIG. 4).

A suitable light source 42 is available from LEDtronics, Inc., http://www.ledtronics.com/, as part number DIS-1024-005A. This light source package contains three light-emitting diodes (LEDs), a red LED operating at a wavelength of about 660 nanometers, a green LED operating at a wavelength of about 586 nanometers, and a blue LED operating at a wavelength of about 430 nanometers, in a single, 4-wire LED package. Other light sources 42, providing different numbers or wavelengths of emitted light, including non-visible wavelengths in the infrared range or ultraviolet range, are also envisioned. The light source should be capable of independent emission of each of the desired wavelengths.

A suitable photo-detector 44 is available from Texas Instruments, http://www.ti.com/, as part number TSL230A. This device outputs a signal with a frequency that is proportional to the amount of light incident on the sensing element. Other devices, such as the Burr-Brown OPT301 integrated optical sensor, which produces a voltage output proportional to the amount of light incident on the sensing element, are also suitable.

A suitable window 38 is available from Edmund Industrial Optics, http://www.edmundoptics.com/, as part number NT43-630, which is a 10.15 millimeter diameter and 1.4 millimeter thick sapphire disk. Sapphire is preferred for its exceptional hardness and superior abrasion resistance in coordination with its good optical properties. The window may be secured directly in a bore in the housing wall with epoxy.

The light source 42 and the photo-detector 44 are mounted on the circuit board 66, which is held in place within the internal cavity by being secured in a slot in an upper sleeve 60, and may be held in the slot using epoxy. A set screw 56 secures the upper sleeve in place after the circuit board 66 and upper sleeve 60 are inserted into the housing 30 and rotated to position light source 42 and photo-detector 44 in alignment with window 38. Associated wiring 68 extends from the circuit board 66 to an electrical connector 70 at an upper end of the housing 30. The electrical connector interfaces with a data/power transmission cable 26 (FIG. 1) extending down to the probe from the ground surface.

Probe 21 also includes a geotechnical sensor section at its lower end. O-rings 50 are used to seal the geotechnical sensor section. The geotechnical sensor section includes strain gages to measure soil-applied load as the probe is advanced through the soil, as known in the field of cone penentrometers. One set of strain gages 52 measures shear stress applied to a sleeve 46 immediately behind the removable tip 48. A second set of strain gages 54 measures the normal load applied to tip 48 parallel to the probe axis as the probe is pushed into the soil. Associated wiring 62 extends from the strain gages 52, 54 to an electrical connector 64 at an upper end of the housing 30. Wiring 62 is preferably coaxial cable to minimize interference with data signals. Electrical connector 64 interfaces with data/power transmission cable 26 (FIG. 1) extending down to the probe from the ground surface.

As shown in FIG. 4, transmitted light 74 from light source 42 is directed toward window 38 through channel 78 of light manifold 72. Reflected light 76 (i.e., light reflected by the soil) is directed toward photo-detector 44 through channel 80 of light manifold 72. Light manifold 72 blocks direct incidence of transmitted light 74 upon the photo-detector 44.

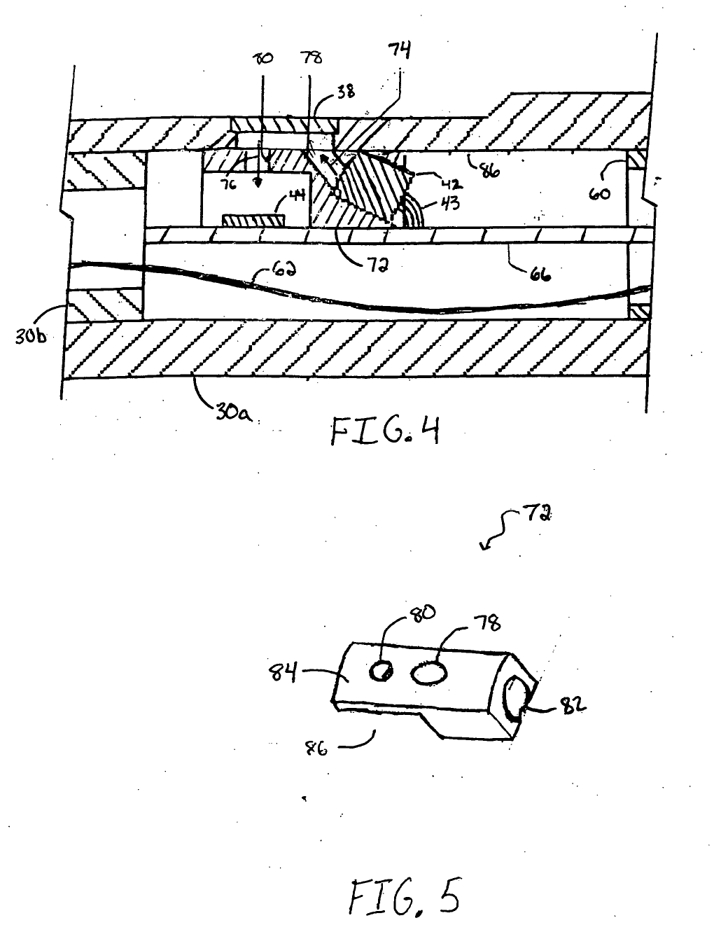

As shown on FIG. 5, light manifold 72 has an arcuate upper surface 84 that mounts snugly against an inner surface 86 (FIG. 4) of the upper section of the probe housing. Light manifold 72 is machined from a solid piece of aluminum and defines an undercut cavity 86 for placement of the photo-detector, and a bore 82 into which the light source is mounted. Light manifold 72 also defines a transmitted light channel 78 leading from bore 82 to upper surface 84, and a separate, reflected light channel 80 leading back from upper surface 84 to cavity 86. As their names imply, transmitted light 74 is directed toward the window through the transmitted light channel, and reflected light 76 is directed toward the photo-detector through the reflected light channel.

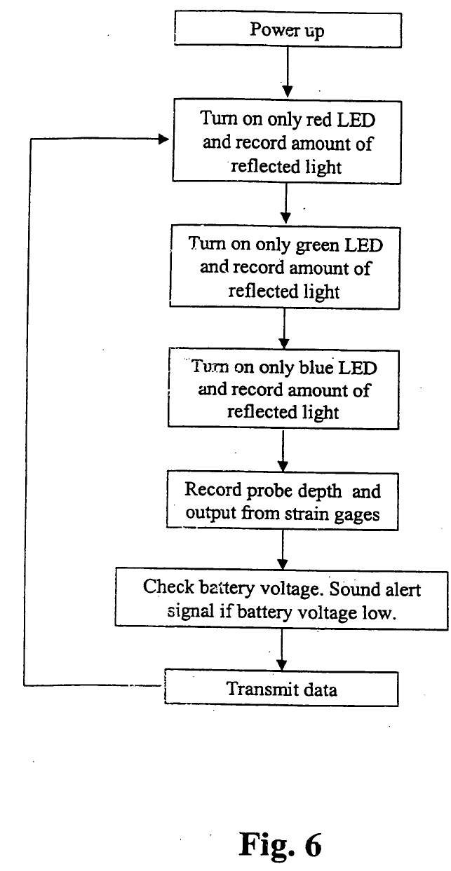

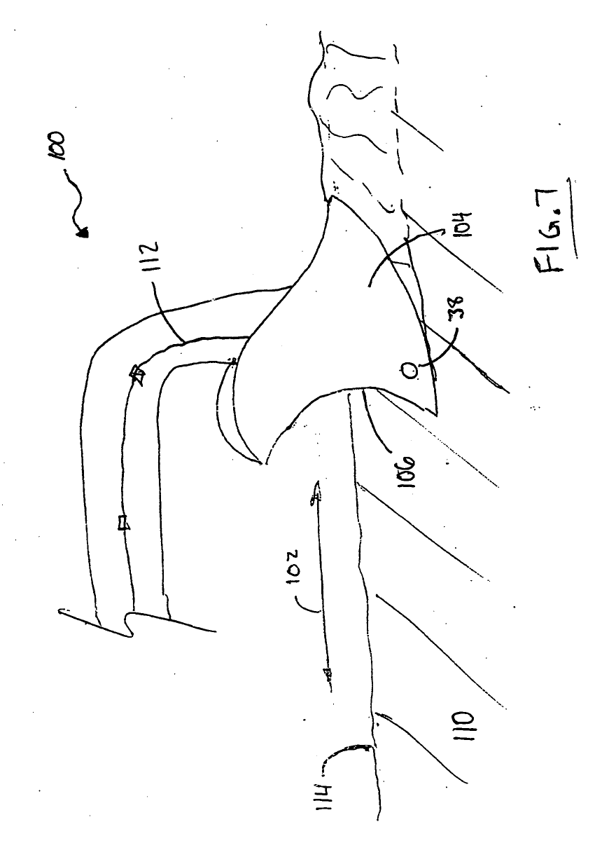

A microprocessor associated with probe controller 19 (FIG. 1) operates probe 21 to perform the steps shown in FIG. 6. The microprocessor turns on each of the colors in the LED package (one at a time, in sequence) while recording the output of the photo sensor, thus measuring an amount of light reflected from the soil at each of the three wavelengths of light that the LED package produces. The microprocessor also measures the output from the tip and sleeve load sensors. After power up, the microprocessor turns on only the red LED and records the amount of reflected light for approximately 0.125 seconds. Next, the microprocessor turns on only the green LED and records the amount of reflected light for approximately 0.125 seconds. Next, the microprocessor turns on only the blue LED and records the amount of reflected light for approximately 0.125 seconds. The microprocessor then records the probe depth and the output from the strain gages. The microprocessor checks the battery voltage and sounds an alert signal if the battery voltage is low. The microprocessor then transmits the data as a digital sequence to the data acquisition computer. Under normal operating conditions, this cycle is repeated on an ongoing basis until the system is powered down.

Referring back to FIG. 1, an ultrasonic distance measurement device 22 mounted on the vehicle monitors the depth of the sensor in the ground and the microprocessor logs the output of the depth sensor to correlate all measurements to depth. The system is powered by a battery, and the battery voltage is also monitored by the microprocessor. As data is collected, the data is sent out by the microprocessor as plain text over a serial interface line (RS-232) 28 to a personal computer 24. The personal computer is used to record the data, display the data graphically, and apply any calibration factors or unit conversions.

Referring to FIG. 7, a color sensor plow 100 measures soil color properties while traveling horizontally through soil 110 along a force axis 102. A window 38 is mounted in an opening in the body 104 of the plow. Preferably, the window 38 is positioned on a plow blade 106 so as to be in substantially continuous contact with the soil 110 without receiving direct impact load of the soil 110 while plowing. Wiring 112 provides data and power transmission between a controller on a tractor (not shown) pulling the color sensor plow 100. Alternatively, sensor components in the plow body 104 could be powered by a local battery with data transmitted wirelessly.

The color sensor described above may also be combined in a single probe with other sensors, such as those responsive to soil density, texture, moisture, resistivity, temperature or imagery. The output from the various sensors is preferably correlated to depth or field position (such as with a depth gage and/or a global positioning system) so as to enable the association of sensor output with vertical and/or lateral position in the soil. The color sensor can also be deployed in a probe driven into the soil to shallow depths by hand. In addition to pushing the probe into the soil, it is also conceivable that a device containing the color sensor can be hammered into the subsurface or dragged at a given depth horizontally across a field.

In some applications, the color sensor is pushed into the soil at various locations across a field so as to create vertical color profiles. In agricultural applications, these color profiles typically will be created to a depth of approximately two meters. At select locations, soil can be removed from the ground in the form of a core sample directly adjacent to the location of the color sensor profile. The core can be analyzed by sending various sections to a laboratory to determine soil organic carbon content, nutrient levels (nitrogen, phosphorous, potassium), and color. These results are then used to calibrate the output of the color sensor to one of those measured properties for a particular site. Likewise, sections of the core can be analyzed for soil texture (grain size), bulk density and moisture for the purpose of calibrating the sensors on the probe that are intended to indicate these soil properties. Cores only need to be taken at a few locations in order to calibrate sensor response for a given type of soil. Core samples or other objects of a known color can be held against the color sensor window to determine probe calibration factors. The probe can also be calibrated with the Munsell soil color chart. Each standard Munsell color chip can be placed over the window and the color of the chip plotted in three-dimensional R-G-B space. When the probe is later employed to obtain an R-G-B value of soil color in situ, the field R-G-B values are plotted into the same color space and a minimum distance-to-mean algorithm employed to determine which of the Munsell chips is closest to the field color measurement in Euclidean space. The output of the algorithm can be the identification of the closest Munsell soil color, or a weighted function of the three or four closest Munsell samples. Once a database of sensor response to specific soil types is determined, further core sampling may not be necessary for acceptable accuracy.

It has been shown in research studies that the percent soil organic matter in a soil is nearly linearly related to soil color within a given landscape. See, for example, Shulze et al., “The Significance Of Organic Matter In Determining Soil Color”, Soil Sci. Soc. Amer. Special Publ., No. 31, pp 71-90 (1993). Fertilizers and other nutrients have a positive ionic charge and are thus chemically adsorbed and held onto negatively charged organic matter particles. The more organic matter that a soil contains, both in concentration and volume, the higher the nutrient holding capacity. In addition, the texture and density of a soil impacts the ability of the soil to physically hold moisture. Since the nutrients are often dissolved into soil water, they will migrate through the soil with the water. By measuring the soil texture and density, it is also possible to determine the physical nutrient holding capacity of the soil environment.

Once the vertical soil organic matter and nutrient holding capacity is determined at selected areas in a field, the conditions that exist between observations can be interpreted. This can be accomplished using a variety of spatial statistical routines that estimate conditions across the site in three dimensions. The resulting map can be imported into applications that utilize the information for decision support. For example, the data can be employed to modify the distribution of materials applied by a variable rate fertilizer applicator. Organic matter distribution data may also be employed to calculate an overall carbon sequestration amount for a given field, such as for determining carbon credits in a carbon emission control program.

A number of embodiments of the invention have been described. Nevertheless, it will be understood that various modifications may be made without departing from the spirit and scope of the invention. Accordingly, other embodiments are within the scope of the following claims.

What is claimed is:

1. A soil measurement probe comprising
a housing (30,104) defining a force axis (32) and having an outer surface (34) exposed for sliding contact with soil (110) as the housing is moved through the soil along its force axis, the housing defining an interior cavity (36) therein;
a window (38) mounted in an opening (40) in the outer surface of the probe and providing optical communication between the soil and the interior cavity;
illumination means (42), disposed within the interior cavity and directed toward the window (38), for illuminating the soil in situ with multiple light wavelengths in succession; and
sense means (44) disposed within the interior cavity and directed toward the window (38), the sense means responsive to light of each of the first and second wavelengths as reflected from the soil in situ.

2. The soil measurement probe of claim 1, wherein the illumination means (42) is controllable to selectively illuminate the soil (110) with the first and second wavelengths in succession.

3. The soil measurement probe of claim 2, wherein the illumination means (42) is also controllable to selectively illuminate the soil (110) with a third wavelength to the exclusion of the first and second wavelengths.

4. The soil measurement probe of claim 3, wherein the first, second, and third wavelengths correspond to visible colors of red, green, and blue.

5. The soil measurement probe of claim 1, wherein the first and second wavelengths correspond to visible colors.

6. The soil measurement probe of claim 5, wherein each of the first and second wavelengths corresponds to a different one of red, green, and blue visible colors.

7. The soil measurement probe of claim 1, wherein the window (38) has an outer surface substantially flush with the outer surface (34) of the probe.

8. The soil measurement probe of claim 7, wherein the window (38) is flush with a flat region (39) of the outer surface (34) of the probe.

9. The soil measurement probe of claim 8, wherein the flat region (39) is open at its lower end, providing an unobstructed path for soil approaching the window (38).

10. The soil measurement probe of claim 1, wherein the window (38) comprises sapphire.

11. The soil measurement probe of claim 1, wherein the probe defines an internal passage extending through its length and forming a pass-through for wires (62) from down-probe sensors (52,54).

12. The soil measurement probe of claim 1, wherein the illumination means (42) comprises separate light emitters, with one light emitter configured to emit light at the first wavelength, and another light emitter configured to emit light at the second wavelength.

13. The soil measurement probe of claim 12, wherein the light emitters comprise light-emitting diodes.

14. The soil measurement probe of claim 1, further comprising a light manifold (72) defining:
an illumination channel (78) positioned to direct light from the illumination means (42) to an interior surface of the window (38); and
a reflection channel (80) spaced apart from the illumination channel and positioned to provide an optical path from the interior surface of the window to the sense means (44).

15. The soil measurement probe of claim 1, wherein the sense means (44) comprises a light-responsive integrated circuit that outputs a signal with a frequency that varies with light intensity.

16. The soil measurement probe of claim 1, further comprising a controller (19) adapted to trigger the illumination means (42) to emit light at the first wavelength, then to cease to emit light at the first wavelength, and to subsequently emit light at the second wavelength.

17. The soil measurement probe of claim 16, wherein the controller (19) is connected to the illumination means (42) via a length of cable (26) extending from the housing (30,104).

18. The soil measurement probe of claim 16, wherein the controller (19) triggers distinct emissions of each of the first and second wavelengths within a total elapsed time of less than about one second.

19. The soil measurement probe of claim 16, wherein the controller (19) is adapted to trigger the illumination means (42) while the probe is advancing through the soil (110).

20. The soil measurement probe of claim 1, further comprising an electrical connector (70) at an upper end of the housing (30), for interfacing with a data transmission cable (26) extending down to the probe from the ground surface.

21. The soil measurement probe of claim 1, wherein the housing (30) comprises a generally cylindrical body with a closed downhole end (48).

22. The soil measurement probe of claim 21, wherein the downhole end (48) includes a force sensor (52,54) configured to measure soil-applied load as the probe is advanced through the soil (110) along the force axis (32).

23. The soil measurement probe of claim 22, wherein the downhole end includes a first force sensor (54) responsive to normal load applied parallel to the force axis at a distal tip of the probe, and a second force sensor (52) responsive to shear stress applied to the outer probe surface behind the tip.

24. The soil measurement probe of claim 1, wherein the housing (30) has a buckling strength sufficient to withstand an unsupported load of at least two tons (18 kilonewtons) applied along the force axis (32).

25. The soil measurement probe of claim 1, wherein the housing (104) is shaped to cleave the soil (110) as it is moved laterally through the soil.

26. The soil measurement probe of claim 1, wherein the sense means (44) comprises a light-responsive integrated circuit.

27. A method of measuring color response of soil, the method comprising
advancing a probe (21,100) through subsurface soil (110);
shining a light of a first wavelength into the soil in situ through a window (38) in a side surface of the probe;
measuring a first amount of light reflected by the soil back into the probe in response to shining the light of the first wavelength; then, after extinguishing the light of the first wavelength,
shining a light of a second wavelength into the soil in situ through the window; and
measuring a second amount of light reflected by the soil back into the probe in response to shining the light of the second wavelength.

28. The method of claim 27, wherein the first and second wavelengths each corresponds to a different one of red, green and blue visible colors.

29. The method of claim 28, further comprising deriving a numeric R-G-B representation of color of the soil.

30. The method of claim 27, further comprising, after measuring a second amount of light reflected by the soil (110) back into the probe (21) in response to shining the light of the second wavelength:
shining a light of a third wavelength into the soil in situ through the window (38); and measuring a third amount of light reflected by the soil back into the probe in response to shining the light of the third wavelength.
